(19) United States
(12) Patent Application Publication
(10) Pub. No.: US 2026/0080140 A1
(43) Pub. Date: Mar. 19, 2026

(54) METHOD AND SYSTEM FOR LARGE-SCALE LINEAR CIRCUIT SIMULATION, CIRCUIT SIMULATOR AND STORAGE MEDIUM

(71) Applicant: SOUTHERN UNIVERSITY OF SCIENCE AND TECHNOLOGY, Shenzhen, Guangdong (CN)

(72) Inventors: Quan CHEN, Shenzhen (CN); Hang ZHOU, Shenzhen (CN); Dinglun XIA, Shenzhen (CN); Xiaoma WU, Shenzhen (CN)

(73) Assignee: SOUTHERN UNIVERSITY OF SCIENCE AND TECHNOLOGY, Shenzhen, Guangdong (CN)

(21) Appl. No.: 19/109,727

(22) PCT Filed: Oct. 13, 2023
(86) PCT No.: PCT/CN2023/124550

§ 371 Date: Mar. 7, 2025

(30) Foreign Application Priority Data
Jul. 26, 2023 (CN) 202310929719.2

(51) Int. Cl. G06F 30/392; G06F 17/13; G06F 111/10

(52) U.S. Cl. CPC G06F 30/392; G06F 17/13; G06F 2111/10

(57) ABSTRACT

A method and a system for large-scale linear circuit simulation, a circuit simulator and a storage medium are provided. The method includes: constructing ordinary differential equations for a linear circuit and converting the ordinary differential equations into a large-scale sparse system of linear equations; performing column reordering on a coefficient matrix of the large-scale sparse system of linear equations, obtaining a pre-reordered matrix; utilizing partitioning partition algorithm to perform row-column reordering, obtaining a doubly bordered-block diagonal matrix; employing a plurality of compute nodes, solving for local Schur complements of each of the distributed nodes, and summing up the local Schur complements to obtain a global Schur complement; solving for states of each of the distributed nodes at a current time step; and converting solution results from all time steps of each of the distributed nodes into a simulation result. The method significantly improves simulation efficiency while ensuring smooth simulation execution.

### FIELD OF THE APPLICATION

The present disclosure relates to the field of numerical simulation technology for analog circuits, and in particular to a method and a system for large-scale linear circuit simulation, a circuit simulator, and a storage medium.

### BACKGROUND

Large-scale circuits at advanced nodes have reached a scale of tens of millions to hundreds of millions, posing enormous challenges to circuit simulators. For example, under requirements of multifunctionality in modern electronic products and emerging mixed-domain design needs, performance requirements for various analog, digital, electromagnetic, RF, and thermal modules at chips, packages, and systems based on an ultra-large-scale integrated circuit are becoming increasingly high. Additionally, continuously increasing operating frequencies bring about various effects that cannot be ignored, such as delays, distortions, reflections, and crosstalk.

In the prior art, core steps for large-scale circuit simulation involve sparse matrix factorization. Currently, most methods use matrix reordering methods to decompose sparse matrices. However, the methods fail to obtain and control number and sizes of matrix blocks, leading to lower efficiency in a circuit simulation.

### BRIEF SUMMARY OF THE DISCLOSURE

In view of the deficiencies in the prior art, the objective of the present disclosure is to provide a method and a system for a large-scale linear circuit simulation, a circuit simulator, and a storage medium, aimed to overcome the shortcoming of low efficiency in the large-scale linear circuit simulation the prior art.

To achieve the objectives, a first aspect of the present disclosure provides a method for large-scale linear circuit simulation, including following steps:
constructing ordinary differential equations for a linear circuit based on a scale of the linear circuit, and converting the ordinary differential equations for the linear circuit into a large-scale sparse system of linear equations utilizing Euler iteration method;
performing column reordering on a coefficient matrix of the large-scale sparse system of linear equations to ensure all diagonal elements of the coefficient matrix are non-zero, obtaining a pre-reordered matrix;
utilizing graph partitioning algorithm to perform row-column reordering on the pre-reordered matrix to ensure the non-zero elements are distributed along a diagonal, a right border, and a lower border, obtaining a doubly bordered-block diagonal matrix;
employing a plurality of compute nodes to form distributed nodes, solving for local Schur complements of each of the distributed nodes based on data from the doubly bordered-block diagonal matrix, and summing up the local Schur complements to obtain a global Schur complement;
solving states of each of the distributed nodes at a current time step in parallel, based on the global Schur complement and solution results from each of the distributed nodes at a previous time step; converting the solution results from all time steps of each of the distributed nodes into a simulation result for the large-scale linear circuit, based on the column reordering and the row-column reordering.

Further, the utilizing graph partitioning algorithm to perform row-column reordering on the pre-reordered matrix to ensure the non-zero elements are distributed along a diagonal, a right border, and a lower border, obtaining a doubly bordered-block diagonal matrix, includes:
creating an original graph stack to store original graphs and a subgraph stack to store subgraphs obtained by bipartitioning, the original graphs are undirected graphs corresponding to the pre-reordered matrix;
popping each of the original graphs sequentially from the original graph stack, bipartitioning the original graphs into the subgraphs to obtain bipartite subgraphs; pushing the bipartite subgraphs into the subgraph stack until the original graph stack becomes empty, swapping the original graph stack and the subgraph stack;
repeating a process of bipartitioning each of the original graphs into the subgraphs and swapping the original graph stack and the subgraph stack until a number of the bipartite subgraphs in the subgraph stack or the number of swaps between the original graph stack and the subgraph stack reaches a predetermined number;
utilizing all the bipartite subgraphs to perform the row-column reordering on the pre-reordered matrix to ensure the non-zero elements are distributed along the diagonal, the right border, and the lower border, obtaining the doubly bordered-block diagonal matrix.

Further, the popping each of the original graphs sequentially from the original graph stack, bipartitioning the original graphs into the subgraphs to obtain bipartite subgraphs, includes:
obtaining sizes of all the original graphs popped from the original graph stack;
presetting a bipartite subgraph size threshold based on global information from all the bipartite subgraphs obtained from a previous bipartition, when the size of one original graph exceeds the preset bipartite subgraph size threshold, bipartitioning the one original graph into the subgraphs to obtain the bipartite subgraphs; otherwise, setting the one original graph as the bipartite subgraph.

Further, the utilizing all the bipartite subgraphs to perform the row-column reordering on the pre-reordered matrix, ensuring the non-zero elements are distributed along the diagonal, the right border, and the lower border, obtaining the doubly bordered-block diagonal matrix, includes:
presetting a column reordering matrix, a doubly bordered-block diagonal reordering matrix, a row scaling matrix, and a column scaling matrix based on a dimension of the coefficient matrix;
ensuring the coefficient matrix has elements on the diagonal with an absolute value of 1, and the absolute values of off-diagonal elements do not exceed 1, based on the column reordering matrix, the row scaling matrix, and the column scaling matrix, obtaining the pre-reordered matrix;
constructing a doubly bordered-block diagonal reordering form based on the graph partitioning algorithm, and utilizing the doubly bordered-block diagonal reordering form to perform the row-column reordering on the pre-reordered matrix, obtaining the doubly bordered-block diagonal matrix.

Further, the employing a plurality of compute nodes to form distributed nodes, solving for local Schur complements of each of the distributed nodes based on data from the doubly bordered-block diagonal matrix, and summing up the local Schur complements to obtain a global Schur complement, includes
utilizing the plurality of compute nodes to form the distributed nodes, storing the data from the doubly bordered-block diagonal matrix on a target node, and designating the target node as a master node, designating all other nodes as slave nodes;
broadcasting data from the master node to all the slave nodes by utilizing a first message passing interface function, and solving the local Schur complements for the all distributed nodes;
summing the local Schur complements by utilizing a second message passing interface function to obtain the global Schur complement.

Further, the broadcasting the data from the master node to all the slave nodes by utilizing a first message passing interface function, and solving the local Schur complements for the all distributed nodes, includes:
filtering elements in the doubly bordered-block diagonal matrix corresponding to each of the distributed nodes based on the data from the master node, and constructing a block matrix by utilizing the elements corresponding to each of the distributed nodes;
solving each of the block matrices by utilizing parallel computing method to obtain the local Schur complements for each of the distributed nodes.

Further, converting the solution results from all time steps of each of the distributed nodes into a simulation result for the large-scale linear circuit, includes:
solving the state of each of the distributed nodes at the current time step in parallel based on the global Schur complement and the solution results from each of the distributed nodes at the previous time step;
identifying rows in the large-scale linear circuit simulation result corresponding to the solution results from all time steps of each of the distributed nodes, based on the column reordering matrix and the doubly bordered-block diagonal reordering matrix;
scaling all elements in the rows based on the column scaling matrix to obtain the large-scale linear circuit simulation result.

A second aspect of the disclosure provides a system for a large-scale linear circuit simulation, including:
an initialization module, used to construct an ordinary differential equation for a linear circuit based on a scale of the linear circuit, and convert the ordinary differential equation for the linear circuit into a large-scale sparse system of linear equations utilizing Euler iteration method;
a matrix reordering module, used to perform a column reordering on the coefficient matrix of the large-scale sparse system of linear equations to ensure all the diagonal elements of the coefficient matrix are non-zero, obtaining a pre-reordered matrix; and to utilize graph partitioning algorithm to perform row-column reordering on the pre-reordered matrix to ensure the non-zero elements are distributed along the diagonal and the right and lower borders, obtaining a doubly bordered-block diagonal matrix.
a Schur complement computation module, used to employ a plurality of compute nodes to form distributed nodes, solve for local Schur complements of each of the distributed nodes based on data from the doubly bordered-block diagonal matrix, and sum up the local Schur complements to obtain a global Schur complement;
a circuit simulation module, used to solve states of each of the distributed nodes at a current time step in parallel, based on the global Schur complement and solution results from each of the distributed nodes at a previous time step; and convert the solution results from all time steps of each of the distributed nodes into a simulation result for the large-scale linear circuit, based on the column reordering and the row-column reordering.

A third aspect of the present disclosure provides a circuit simulator, the circuit simulator includes a simulation chip, a memory, and a large-scale linear circuit simulation program stored on the memory and executable on the simulation chip; when executed by the simulation chip, the large-scale linear circuit simulation program implements the steps of the large-scale linear circuit simulation method as described in any of the methods.

A fourth aspect of the present disclosure provides a computer-readable storage medium, the computer-readable storage medium stores a large-scale linear circuit simulation program, when executed by a processor, the program implements the steps of the method for large-scale linear circuit simulation method as described in any of the methods.

Compared with the prior art, beneficial effects of the present disclosure are as follows:

The present disclosure first constructs ordinary differential equations for the a linear circuit based on a scale of the linear circuit, and converts the ordinary differential equations into a large-scale sparse system of linear equations utilizing the Euler iteration method; and then performs column reordering on a coefficient matrix of the large-scale sparse system of linear equations to ensure all the diagonal elements are non-zero to obtain a pre-reordered matrix; further, the present disclosure utilizes the graph partitioning algorithm to perform row-column reordering on the pre-reordered matrix to ensure the non-zero elements are distributed along a diagonal, a right border, and a lower border, thereby obtaining a doubly bordered-block diagonal matrix. The process effectively controls a number and sizes of matrix partitions, ensuring a smooth execution of subsequent simulation steps. Next, a plurality of compute nodes are employed to form distributed nodes to solve for local Schur complements of each of the distributed nodes based on data from the doubly bordered-block diagonal matrix, and then the local Schur complements are summed up to obtain a global Schur complement, enhancing simulation efficiency. Following, states of each of the distributed nodes at a current time step is solved in parallel based on the global Schur complement and solution results from each of the distributed nodes at a previous time step, accelerating the circuit simulation efficiency. Finally, the solution results from all time steps of each of the distributed nodes are converted into a simulation result for the large-scale linear circuit.

As evident, the present disclosure converts ordinary differential equations of large-scale linear circuits into appropriately dimensional large-scale sparse system of linear equations based on the scale of the large-scale linear circuits, to control the number and sizes of the matrix partitions, ensuring the smooth execution of the simulation efficiency. By employing parallel processing of each of the slave nodes, the present disclosure significantly enhances the simulation efficiency of circuits.

### BRIEF DESCRIPTION OF THE DRAWINGS

To more clearly describe the technical solutions of the embodiments of the present disclosure, a brief introduction to the accompanying drawings used in the description of the embodiments or prior art is provided below. It is evident that the drawings described below are merely some embodiments of the present disclosure. For those ordinary skilled in the art, other drawings can be obtained from the drawings without making inventive efforts.

FIG. 1 is a flowchart of a method for large-scale linear circuit simulation of the present disclosure;

FIG. 2 is a flowchart of a specific process of the method for large-scale linear circuit simulation of the present disclosure;

FIG. 3 is a schematic diagram illustrating a principle of reordering on a matrix into a BBD form in the prior art;

FIG. 4 is a structural diagram of a system of the present disclosure;

FIG. 5 is a structural diagram of a circuit simulator of the present disclosure.

### DETAILED DESCRIPTION

In the following description, specific details such as particular system structures and technologies are provided for illustrative purposes and not limitation, to facilitate a thorough understanding of the embodiments of the present disclosure. However, those skilled in the art should understand that the present disclosure can also be implemented in other embodiments without the specific details. In other cases, well-known systems, devices, circuits, and methods are not described in detail to avoid obscuring the description of the present disclosure with unnecessary details.

It should be understood that, when used in the specification and the appended claims, the terms “include” or “comprise” indicates the presence of the described features, integers, steps, operations, elements, components, and/or groups thereof, but does not preclude the existence or addition of one or more other features, integers, steps, operations, elements, components, and/or collections thereof.

It should also be understood that the terms used in the present disclosure are employed for the purpose of describing particular embodiments only and are not intended to limit the present disclosure. Unless otherwise indicated by the context, as used in the present disclosure and the appended claims, singular forms such as “a”, “an”, and “the” are intended to include the plural forms as well.

It should also be further understood that the terms “and/or” used in the present disclosure and the appended claims refer to any combination of one or more of the associated listed items, as well as all possible combinations thereof, and include the combinations.

The following is a clear and complete description of the technical solutions in the embodiments of the present disclosure with reference to the accompanying drawings of the embodiments. Clearly, the described embodiments are only a part of the embodiments of the present disclosure, not all of them. Based on the embodiments of the present disclosure, all other embodiments obtained by those ordinary skilled in the art without making inventive efforts fall within the scope of protection of the present disclosure.

In the following description, many specific details are set forth to enable a thorough understanding of the present disclosure. However, the present disclosure can also be implemented in other ways different from those described here. Those skilled in the art can make similar extensions without departing from the spirit of the present disclosure. Therefore, the present disclosure is not limited to the specific embodiments disclosed below.

The present disclosure targets linear circuits and employs Metis library to reorder sparse matrices into a form where non-zero elements are concentrated around a diagonal, a right side, and a bottom side, referred to as BBD form. Based on a scale of a linear circuit, ordinary differential equations for the linear circuit are constructed. By utilizing Euler iteration method, the ordinary differential equations are converted into a large-scale sparse system of linear equations. By modifying existing partitioning strategy of the Metis library, a recursive depth-first partition strategy is changed to a loop-based breadth-first partitioning strategy, which allows control over the number and the sizes of matrix partitions. For each of distributed nodes, an efficient solver tailored for circuit matrices is adopted, significantly reducing simulation time. According to characteristics of the linear systems, corresponding mathematical conversions are performed so that during the simulation process, each of the distributed nodes does not need to obtain a complete simulation result or compute complete simulation inputs. The method reduces computational load, minimizes memory usage, decreases communication between distributed nodes, and increases speedup ratio.

### Exemplary Method

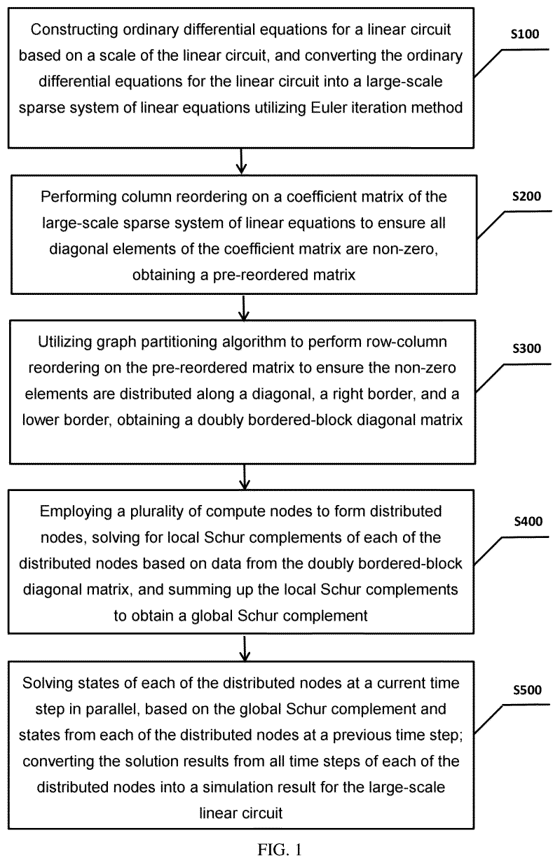

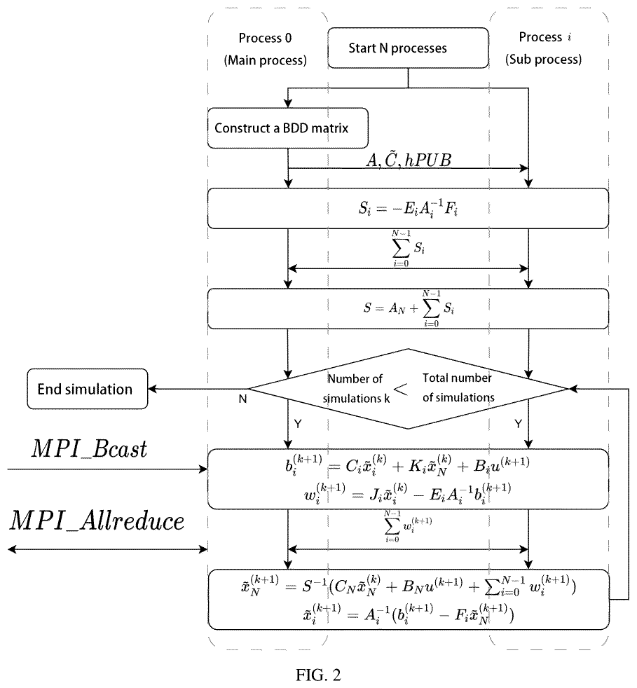

The embodiment of the present disclosure provides a method for large-scale linear circuit simulation, deployed on electronic devices such as computers and servers, with application scenarios on large-scale linear circuit simulations. The method targets sparse matrix reordering and parallel processing situations. Types of physical quantities represented by the nodes in the large-scale linear circuits are not limited and can include voltages, currents, and other physical quantities present in linear circuits. As shown in FIG. 1 and FIG. 2, the process of the embodiment method includes:

Step S100: Constructing ordinary differential equations for a linear circuit based on a scale of the linear circuit, and converting the ordinary differential equations for the linear circuit into a large-scale sparse system of linear equations utilizing Euler iteration method.

Since a core of circuit simulation is solving the large-scale sparse system of linear equations Ax=b, the embodiment sets a number of activated processes N based on the scale of the linear circuit. According to the number of activated processes N, the large-scale sparse system of linear equations Ax=b in BBD form is constructed, where A is a non-singular BBD matrix with N diagonal blocks, and both x and b are vectors, length of both x and b are the same.

Firstly, the mathematical form of solving BBD matrices is described. Here, A is defined as having a BBD form where non-zero elements are concentrated along a diagonal, a right border, and a lower border. Non-zero elements are distributed in blocks near the diagonal, denoted as A₀, . . . , A_{N-1}. Non-zero elements distributed along the lower and the right borders are divided into matrix blocks based on sizes of the diagonal blocks, denoted as E₀, . . . , E_{N-1} and F₀ . . . , F_{N-1}. An intersection area of the two borders with the diagonal is represented by a matrix block A_{N}. Vectors x and b are divided into corresponding segments based on partitioning method of A. The corresponding large-scale sparse system of linear equations is

$$Ax = [ \begin{matrix}{A}_{0} & & & {F}_{0} \\ & ⋱ & & ⋮ \\ & & {A}_{N - 1} & {F}_{N - 1} \\ {E}_{0} & … & {E}_{N - 1} & {A}_{N}\end{matrix} ] [ \begin{matrix}{x}_{0} \\ ⋮ \\ {x}_{N - 1} \\ {x}_{N}\end{matrix} ] = [ \begin{matrix}{b}_{0} \\ ⋮ \\ {b}_{N - 1} \\ {b}_{N}\end{matrix} ] = b \qquad ( 1 )$$

For x₀ to x_{N-1},

$$there is {A}_{i} {x}_{i} = {b}_{i} - {F}_{i} {x}_{N} , i = 0 , … , N - 1 \qquad ( 2 )$$

The equation for a row with x_{N}, after substituting x₀ to x_{N-1} with x_{N} according to Equation (2), rearranging to obtain

$$S {x}_{N} = ( {A}_{N} - {\sum }_{i = 0}^{N - 1} {E}_{i} {A}_{i}^{- 1} {F}_{i} ) {x}_{N} = {b}_{N} - {\sum }_{i = 0}^{N - 1} {E}_{i} {A}_{i}^{- 1} {b}_{i} \qquad ( 3 )$$

Among them, −EᵢAᵢ⁻¹Fᵢ is referred to as a local Schur complement, and

$${A}_{N} - {\sum }_{i = 0}^{N - 1} {E}_{i} {A}_{i}^{- 1} {F}_{i}$$

is referred to as a global Schur complement, denoted as S.

It should be noted that the size of N in Equation (1) is the same as the number of activated processes, representing a sum of a master node and slave nodes in the circuit matrix (i.e., the coefficient matrix), with only one master node.

Converting the ordinary differential equations for the linear circuit into the large-scale sparse system of linear equations utilizing the Euler iteration method. The ordinary differential equations for the linear circuit in the embodiment is:

$$C \dot{x} ( t ) + G x ( t ) = B u ( t ) \qquad ( 4 )$$

Among them, x is referred to as voltage values at each of the nodes of the circuit and current values of some branches, u is referred to as an input of the circuit, C is referred to as capacitive and inductive parts of the circuit, G is referred to as a resistive part of the circuit; and B is referred to as an input matrix of the circuit.

Since not all nodes have inputs, u requires to be processed. In the embodiment, differential terms are linearly approximated with a time step of h, and the ordinary differential equations are discretized into a form of backward Euler iteration as follows:

$$( C + h G ) {x}^{( k + 1 )} = C {x}^{( k )} + h B {n}^{( k + 1 )} \qquad ( 5 )$$

The form is referred to as Ax=b, where C+hG is referred to as a sparse matrix. In the embodiment, the matrix is used as an input for a circuit simulation.

Step S200: Performing column reordering on a coefficient matrix of the large-scale sparse system of linear equations to ensure all diagonal elements of the coefficient matrix are non-zero, obtaining a pre-reordered matrix.

To apply the BBD algorithm, first, an original matrix is reordered into the BBD form. A feasibility of solving the BBD matrices hinges on an invertibility of each of sub-matrices on the diagonal. Since an absolute invertibility of the sub-matrices is difficult to guarantee, a condition is relaxed to a structural invertibility. A structural invertibility of the sparse matrix is equivalent to existence of a reordering method that ensures all elements on the diagonal of the doubly bordered-block diagonal matrix are non-zero. Therefore, the embodiment first uses the existing MC64 library to reorder the matrix. The MC64 library is part of the HSL collection, developed by the Computational Mathematics Group and other experts under UK Research and Innovation for large-scale scientific computing. After processing by the MC64, a corresponding result is:

$$C + h G \to U ( C + h G ) Q V$$

Among them, Q is a column reordering matrix that ensures all the elements on the diagonal of the doubly bordered-block diagonal matrix are non-zero. U and V are row scaling matric and column scaling matric, which ensure after processing by the MC64, all elements on the diagonal have an absolute value of 1, while other elements have an absolute value not exceeding 1 to obtain the pre-reordered matrix to facilitate subsequent LU decomposition.

Step S300: Utilizing the graph partitioning algorithm to perform row-column reordering on the pre-reordered matrix, ensuring the non-zero elements are distributed along a diagonal, a right border, and a lower border, obtaining a doubly bordered-block diagonal matrix.

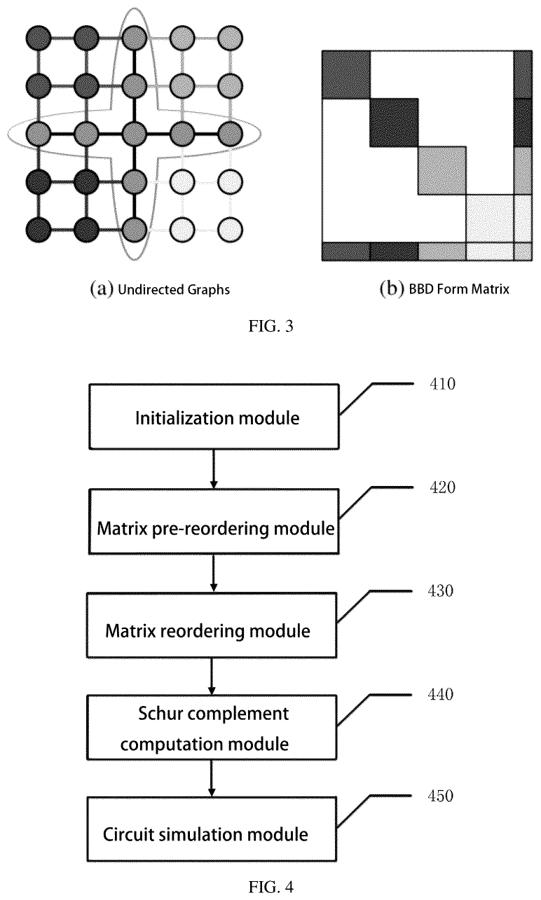

Based on the Metis, the matrix is reordered into the BBD form utilizing the graph partitioning algorithm, as illustrated in the schematic diagram shown in FIG. 3. FIG. 3(a) shows the undirected graphs corresponding to the pre-reordered matrix, while FIG. 3(b) shows subgraphs after bipartitioning reordered into the BBD form matrices. Reordering into the BBD form is equivalent to finding a set of vertices in the undirected graphs, commonly referred to as a vertex separator (VS), which are indicated by the curved lines in FIG. 3(a). Through the vertex separator, the undirected graphs can be divided into several disconnected subgraphs. In the prior art, the method for finding the VS based on the Metis involves: first, bipartitioning the undirected graphs corresponding to the matrix to obtain a left graph, a right graph, and the VS; then recursively bipartitioning the left graph until the subgraphs is sufficiently small, and similarly bipartitioning the right graph in the same manner as the left graph; finally obtaining the VS of each of the subgraphs, where all subgraph VSs constitute the VS of the original graphs. Due to the method of bipartitioning the undirected graph is depth-first recursive bipartition method, it is difficult to obtain information about all the subgraphs, making it challenging to control the number of blocks and determine the sizes of each of the blocks. The fundamental reason is that the Metis aims to reorder the matrix to reduce the complexity of the LU decomposition, rather than to obtain a BBD matrix.

Based on method, the embodiment modifies the method to a loop-based breadth-first traversal algorithm. The implementation method is as follows: creating an original graph stack to store original graphs and a subgraph stack to store subgraphs obtained by bipartitioning, in which the original graphs refer to undirected graphs corresponding to the pre-reordered matrix; popping each of the original graphs sequentially from the original graph stack, bipartitioning the original graphs into the subgraphs to obtain bipartite subgraphs; pushing the bipartite subgraphs into the subgraph stack until the original graph stack becomes empty; then swapping the original graph stack and the subgraph stack; repeating a process of bipartitioning each of the original graphs into subgraphs and swapping the original graph stack and the subgraph stack until a number of the bipartite subgraphs in the subgraph stack or the number of swaps between the original graph stack and the subgraph stack reaches a predetermined threshold; utilizing all the bipartite subgraphs to perform row-column reordering on the pre-reordered matrix, ensuring the non-zero elements be distributed along the diagonal, the right border, and the lower border, obtaining the doubly bordered-block diagonal matrix.

First, preparing the two stacks: one for storing the original graphs from the undirected graphs as the original graph stack, and another for storing the subgraphs obtained after bipartitioning as the subgraph stack. Initially, the original graph stack contains the original graphs corresponding to the circuit matrix, while the subgraph stack is empty. Then, popping each of the original graphs from the original graph stack one by one, bipartitioning each of the original graph, and pushing the resulting subgraphs into the subgraph stack until the original graph stack is empty, followed by swapping the two stacks. Repeating steps of bipartitioning the original graphs until the number of subgraphs in the subgraph stack reaches a desired quantity. Finally, placing all matrix blocks corresponding to the obtained subgraphs into a container. For example, if the number of bipartition is performed on each of the original graphs is n, then the final number of divided matrix blocks (i.e., subgraphs in the undirected graphs) will be 2ⁿ. During an actual simulation, the number of matrix blocks can be preset, and the number of bipartition operations are performed on each of the original graphs can be set based on the preset number of matrix blocks. During the bipartition process, the graph partitioning algorithm used in the embodiment can control the size difference between the two subgraphs obtained after bipartitioning a graph to some extent, meaning that by setting the corresponding parameters of the graph partitioning algorithm, the size of the subgraphs obtained from bipartition can be controlled to some extent.

Meanwhile, querying the sizes of the respective subgraphs in the subgraph stack through the container storing the matrix blocks and performing targeted secondary partitioning based on the queried sizes of the matrix blocks, achieving control over the number and the sizes of the circuit matrix partitions, ensuring the subsequent circuit simulation process proceeds normally. In the final subgraph stack, the sizes of the individual subgraphs represent the partition sizes. Arranging the subgraphs in a certain order, which can be in the order within the subgraph stack, or rearranged based on the sizes of the subgraphs and the computational capabilities of the nodes according to computational load, or can be in any order. Since the subgraphs correspond to matrix blocks, the order of the subgraphs here also determines the left-to-right (or top-to-bottom) order of the diagonal matrix blocks in the BBD matrix.

It should be noted that, after completing the bipartition of any original graph from the original graph stack and pushing the resulting subgraphs into the subgraph stack, information regarding the sizes of all the original graphs and the subgraphs in both stacks becomes available. Additionally, the original graphs and the subgraphs are independent of each other and can be operated on independently.

Furthermore, as an alternative preferred embodiment, a balance processing can be performed based on the modified Metis to ensure the sizes of all the matrix blocks on the main diagonal of the final BBD matrix are roughly equal. The implementation method is as follows: obtaining sizes of all the original graphs popped from the original graph stack; presetting a bipartite subgraph size threshold based on global information from all the bipartite subgraphs obtained from a previous bipartition, if the size of the one original graph exceeds the preset bipartite subgraphs size threshold, bipartitioning the one original graph into the subgraphs to obtain the bipartite subgraph; otherwise, setting the one original graph as the bipartition subgraph. It is evident that the method only requires bipartitioning subgraphs whose sizes exceed the preset threshold, rather than performing the same number of bipartitions on all the graphs in the original graph stack. Consequently, the method achieves control over the number and sizes of the circuit matrix partitions, ensuring the subsequent circuit simulation process proceeds normally.

In the embodiment, the loop-based breadth-first traversal algorithm, which modifies the Metis, allows for a choice between serial processing or parallel processing when bipartitioning each of the original graphs or the subgraphs from the original graph stack, depending on actual needs.

Based on the doubly bordered-block diagonal reordering form constructed in Equation (1), the form is utilized to perform the row-column reordering of the pre-reordered matrix obtained from the previous steps. Since the Metis performs identical reordering on both the rows and columns of the coefficient matrix, the result after reordering is:

$$U ( C + h G ) V Q \to P U ( C + h G ) Q V {P}^{T}$$

Among them, P is refer to as the reordering matrix, which is the same size as the column reordering matrix Q. The difference lies only in the positional relationship during the reordering process, ensuring the non-zero elements of the pre-reordered matrix are distributed along the diagonal, the right border, and bottom border, resulting in the doubly bordered-block diagonal matrix.

Step S400: Employing a plurality of compute nodes to form distributed nodes, solving for local Schur complements of each of the distributed nodes based on data from the doubly bordered-block diagonal matrix, and summing up the local Schur complements to obtain a global Schur complement;

Utilizing the plurality of compute nodes to form the distributed nodes, storing the data from the doubly bordered-block diagonal matrix on a target node, and designating the target node as a master node, while designating all other nodes as slave nodes; broadcasting the data from the master node to the all slave nodes by utilizing a first message passing interface function, and solving the local Schur complements for the all distributed nodes; summing the local Schur complements by utilizing a second message passing interface function to obtaining a global Schur complement.

In the embodiment, the Message Passing Interface (MPI) is used to solve the local Schur complements on each of the nodes and the global Schur complement. MPI is a message passing programming model and standard for parallel computing that allows communication and synchronization between a plurality of processors or computational nodes, thereby enabling parallel computation. In MPI, processes communicate by sending and receiving messages. The embodiment primarily employs two MPI communication functions: the broadcast function (MPI_Bcast) and the global reduction function (MPI_Allreduce). The MPI_Bcast broadcasts data from one node to all other nodes, while the MPI_Allreduce collects data from all nodes, performs an operation on it, and returns the result to the all nodes. In the embodiment, the operation performed is addition, which means, summing up the data from all nodes.

After forming the distributed nodes by utilizing a plurality of computational nodes, the matrix data is typically stored on one node, denoted as the master node and numbered 0, while the remaining nodes are referred to as slave nodes. Due to the circuit matrix being multiplied by matrices on both the left and right sides, Equation (5) can be rewritten as

$$PU ( C + h G ) Q V {P}^{T} \cdot {( QV {P}^{T} )}^{- 1} {x}^{( k + 1 )} = P U C {x}^{( k )} + h P U B {u}^{( k + 1 )} = {b}^{( k + 1 )} \qquad ( 6 )$$

For simplicity, denote

$$A = P U ( C + h G ) Q V {P}^{T} \qquad ( 7 )$$

$${\tilde{x}}^{( k + 1 )} = {( Q V {P}^{T} )}^{- 1} {x}^{( k + 1 )} \qquad ( 8 )$$

Equation (6) can be rewritten as

$$A {\tilde{x}}^{( k + 1 )} = P U C {x}^{( k )} + h P U B {u}^{( k + 1 )} = {b}^{( k + 1 )} \qquad ( 9 )$$

A first equality in Equation (6) has \tilde{x} on one side and x on another side, which means Equation (5) must be solved each time a solution is sought. Equation (6) can be rewritten as follows:

$$A {\tilde{x}}^{( k + 1 )} = P U C Q V {{P}^{T} ( Q V {P}^{T} )}^{- 1} {x}^{( k )} + h P U B {u}^{( k + 1 )} \qquad ( 10 )$$

For simplicity, denote

$$\tilde{C} = P U C Q V {P}^{T} \qquad ( 11 )$$

Substituting Equations (8) and (5) into Equation (6):

$$A {\tilde{x}}^{( k + 1 )} = \tilde{C} {\tilde{x}}^{( k )} + h P U B {u}^{( k + 1 )} = {b}^{( k + 1 )} \qquad ( 12 )$$

The process of solving for the local Schur complements and the global Schur complement of each of the distributed nodes is actually solving for the local Schur complements −EᵢAᵢ⁻¹Fᵢ and the global Schur complement

$${A}_{N} - {\sum }_{i = 0}^{N - 1} {E}_{i} {A}_{i}^{- 1} {F}_{i}$$

### in Equation (3).

First, the local Schur complements are solved. To fully utilize the hardware resources, each of the distributed nodes solves the corresponding local Schur complement. The slave nodes need to obtain matrices Aᵢ, Eᵢ, Fᵢ, A_{N} from the master node to solve the local Schur complement. The most direct method is for the master node to extract each of the sub-matrices and then send to the slave nodes. However, this would waste hardware resources when there are many slave nodes. Due to the fast speed of the MPI_Bcast function and the sparsity of matrix A, based on the data on the master node, filtering the elements from the doubly bordered-block diagonal matrix corresponding to each of the distributed nodes, and constructing a block matrix by utilizing the elements corresponding to each of the distributed nodes. Solving the block matrices in parallel to obtain the local Schur complements for each of the distributed nodes.

In the embodiment, the MPI_Bcast function is chosen to broadcast a matrix A to all the slave nodes, after which each of the slave nodes retrieves the corresponding block. For all the nodes, constructing the block matrix according to Equation (13), denoted as

$$[ \begin{matrix}{A}_{i} & {F}_{i} \\ {E}_{i} & 0\end{matrix} ] \qquad ( 13 )$$

using a solver that supports partial LU decomposition to solve the local Schur complements, which improves solving speed and helps to reduce simulation time. Then, call the function MPI_Allreduce to obtain the sum of the local Schur complements, and add the sum to A_{N} to obtain the global Schur complement.

Step S500: solving states of each of the distributed nodes at the current time step in parallel, based on the global Schur complement and solution results from each of the distributed nodes at the previous time step; and converting the solution results from all the time steps of each of the distributed nodes into a simulation result for the large-scale linear circuit, based on the column reordering and the row-column reordering.

Subsequently, solving the right-hand side of Equation (12). Upon comparing Equations (7) and (11), note that a set of non-zero element positions of matrix C is a subset of a set of non-zero elements C+hG. Therefore, the row-column reordering of matrix C+hG will also reorder matrix C into a BBD matrix. In other words, matrix C is a BBD matrix as well, which means:

$$\tilde{C} = [ \begin{matrix}{C}_{0} & & & {K}_{0} \\ & ⋱ & & ⋮ \\ & & {C}_{N - 1} & {K}_{N - 1} \\ {J}_{0} & … & {J}_{N - 1} & {C}_{N}\end{matrix} ] \qquad ( 14 )$$

Additionally, each sub-matrix of \tilde{C} matches in size with the corresponding sub-matrix of A.

Denote

$$h P U B = {[ \begin{matrix}{B}_{0}^{T} & … & {B}_{N - 1}^{T} & {B}_{N}^{T}\end{matrix} ]}^{T} \qquad ( 15 )$$

The number of rows in Bᵢ is the same as the number of rows in Cᵢ. Combining the with Equations (12), (14), and (15):

$${b}_{i}^{( k + 1 )} = {C}_{i} {\tilde{x}}_{i}^{( k )} + {K}_{i} {\tilde{x}}_{N}^{( k )} + {B}_{i} {u}^{( k + 1 )} \qquad ( 16 )$$

To maximize the utilization of hardware resources, the embodiment requires each of the nodes to solve Equation (3). Additionally, since the simulation results are dense vectors, in order to reduce memory usage, the matrix C and the matrix C+hG can both be converted into BBD form matrices utilizing the same method, which leads to the modified Equation (16). According to Equation (16), each of the nodes only needs to store

$${\tilde{x}}_{i}^{( k )} , {\tilde{x}}_{N}^{( k )}$$

to independently solve bᵢ^{(k+1)}. Therefore, the summation on the right-hand side can be efficiently solved by utilizing the MPI_Allreduce function.

By combining Equations (12), (14), and (15), the following result is obtained:

$${b}_{N}^{( k + 1 )} = {\sum }_{i = 0}^{N - 1} {J}_{i} {\tilde{x}}_{i}^{( k )} + {C}_{N} {\tilde{x}}_{N}^{( k )} + {B}_{N} {u}^{( k + 1 )} \qquad ( 17 )$$

By substituting Equations (16) and (17) into Equation (3), the following result is obtained

$$S {\tilde{x}}_{N}^{( k + 1 )} = {C}_{N} {\tilde{x}}_{N}^{( k )} + {B}_{N} {u}^{( k + 1 )} + {\sum }_{i = 0}^{N - 1} ( {J}_{i} {\tilde{x}}_{i}^{( k )} - {E}_{i} {A}_{i}^{- 1} {b}_{i}^{( k + 1 )} ) \qquad ( 18 )$$

$$Denote$$

$${w}_{i}^{( k + 1 )} = {J}_{i} {\tilde{x}}_{i}^{( k )} - {E}_{i} {A}_{i}^{- 1} {b}_{i}^{( k + 1 )} \qquad ( 19 )$$

$$Therefore$$

$$S {\tilde{x}}_{N}^{( k + 1 )} = {C}_{N} {\tilde{x}}_{N}^{( k )} + {B}_{N} {u}^{( k + 1 )} + {\sum }_{i = 0}^{N - 1} + {w}_{i}^{( k + 1 )} \qquad ( 20 )$$

$$Furthermore$$

$${\tilde{x}}_{i}^{( k + 1 )} = {A}_{i}^{- 1} ( {b}_{i}^{( k + 1 )} - {F}_{i} {\tilde{x}}_{N}^{( k + 1 )} ) \qquad ( 21 )$$

$$Denote$$

$$\begin{matrix}X = [ \begin{matrix}{x}_{0} & … & {x}_{T}\end{matrix} ] , & \tilde{X} = [ \begin{matrix}{\tilde{x}}_{0} & … & {\tilde{x}}_{T}\end{matrix} ]\end{matrix} \qquad ( 22 )$$

$$Thus$$

$$X = QV {P}^{T} \tilde{X} \qquad ( 23 )$$

Thus, the solution results \tilde{X} for all the time steps on each of the distributed nodes are obtained, and the circuit simulation result X are derived according to Equation (23).

Solving the states of each of the distributed nodes at the current time step in parallel based on the global Schur complement and the solution results from each of the distributed nodes at the previous time step; identifying rows in the large-scale linear circuit simulation result corresponding to the solution results from all the time steps of each of the distributed nodes, based on the column reordering matrices and the doubly bordered-block diagonal reordering matrix; scaling all elements in the rows based on the column scaling matrix to obtain the large-scale linear circuit simulation result.

The embodiment leverages the characteristic that the matrix C and the matrix C+hG can both be converted into the BBD form matrices by utilizing the same method, allowing each of the distributed nodes to store only the unknowns (xᵢ^{(k)}) corresponding to the matrix blocks and the unknowns

$${X}_{N}^{( k )}$$

of the coupling parts, and independently solves the right-hand the side vectors (bᵢ^{(k+1)}) corresponding to the matrix blocks. Compared to traditional process of directly computing the right-hand side vector of Equation (5), the method offers three advantages: first, the computational load for solving b (k+1) is distributed across all the nodes, reducing the average computational load per node to 1/N of the computational load in the traditional process; second, the memory required to store x^{(k)} is also distributed across all the nodes, decreasing the average memory usage per node to 1/N of the average memory in the traditional process; third, since there is no need to store entire x^{(k)}, compared to the traditional process, a communication for a collection xᵢ^{(k)} from each of the nodes is reduced, the present disclosure reducing communication rounds by at least one compared to the traditional process.

The present disclosure constructs the ordinary differential equations of the linear circuit based on the scale of the linear circuit, and converts the ordinary differential equations into the large-scale sparse system of linear equations utilizing the Euler iteration method. The method can effectively control the number and the sizes of blocks in the large-scale linear circuit, thereby ensuring the normal progression of subsequent simulation processes. The coefficient matrix is subjected to a plurality of mathematical transformations based on predefined rules to obtain the coefficient matrix that satisfies the BBD form, simplifying the large-scale sparse system of linear equations. This allows each of the distributed nodes to obtain the circuit simulation results without needing the complete simulation results or computing the full simulation input, thus reducing computational load, decreasing memory usage, reducing communication rounds among distributed nodes, and increasing the speedup ratio.

### Exemplary System

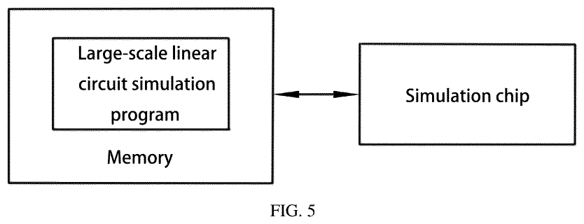

As shown in FIG. 4, corresponding to the large-scale linear circuit simulation method, the present disclosure also provides a system for large-scale linear circuit simulation. The system for large-scale linear circuit simulation system includes:
an initialization module 410, used to construct ordinary differential equations for a linear circuit based on a scale and convert the ordinary differential equations for the linear circuit into a large-scale sparse system of linear equations utilizing the Euler iteration method;
a matrix pre-reordering module 420, used to perform column reordering on a coefficient matrix of the large-scale sparse system of linear equations, ensuring all diagonal elements of the coefficient matrix are non-zero, obtaining a pre-reordered matrix;
a matrix reordering module 430, used to utilize graph partitioning algorithm to perform row-column reordering on the pre-reordered matrix, ensuring the non-zero elements are distributed along the diagonal, the right border and the lower border, obtain a doubly bordered-block diagonal matrix;
a Schur complement computation module 440, used to employ a plurality of compute nodes to form distributed nodes, solve for local Schur complements of each of the distributed nodes based on data from the doubly bordered-block diagonal matrix, and sum up the local Schur complements, obtaining a global Schur complement;
a circuit simulation module 450, used to solve for states of each of the distributed nodes at a current time step in parallel, based on the global Schur complement and solution results from each of the distributed nodes at a previous time step; and convert the solution results from all time steps of each of the distributed nodes into a simulation result for the large-scale linear circuit, based on the column reordering and the row-column reordering.

In the embodiment, functions of the large-scale linear circuit simulation system can refer to the corresponding descriptions in the large-scale linear circuit simulation method, and will not be repeated here.

Based on the embodiments, the present disclosure also provides a circuit simulator, with the principle block diagram shown in FIG. 5. The circuit simulator includes a simulation chip, a memory, and a large-scale linear circuit simulation program stored in the memory and executable on the simulation chip. Execution of the large-scale linear circuit simulation program by the simulation chip realizes the steps of any of the large-scale linear circuit simulation method.

Those skilled in the art can understand that the principle block diagram shown in FIG. 5 illustrates only structural components relevant to the disclosed solution and do not constitute a limitation on the circuit simulator to which the disclosed solution is applied. The specific circuit simulator may include more or fewer components than those shown in the drawings, or certain components may be combined, or there may be different component arrangements.

An embodiment of the present disclosure also provides a computer-readable storage medium, which stores a large-scale linear circuit simulation program. When executed by a processor, the large-scale linear circuit simulation program implements steps of any of the large-scale linear circuit simulation method provided by the embodiments of the present disclosure.

It should be understood that the size of the sequence numbers of each step in the embodiments does not indicate the order of execution; the execution order of each process should be determined by its function and intrinsic logic, and shall not constitute any limitation on the implementation process of the embodiments of the present disclosure.

Those skilled in the art can clearly understand that, for the convenience and brevity of description, only the division of the functional units and modules is illustrated by way of example. In practical applications, the functions can be allocated to different functional units or modules based on a requirement, the internal structure of the above device can be divided into different functional units or modules to complete all or part of the functions described above. In the embodiments, each of the functional units and modules can be integrated into one processing unit, can also exist physically separately, or two or more units can be integrated into one unit. The integrated units can be implemented in the form of hardware or in the form of software functional units. Additionally, the specific names of each of the functional units and modules are merely for ease of differentiation and are not used to limit the scope of protection of the present disclosure. The specific working processes of the units and modules in the system can refer to the corresponding processes in the previously described method embodiments, which will not be reiterated here.

In the embodiments, each of the embodiments is described with a specific emphasis. Parts not detailed or mentioned in one embodiment can be referred to in the descriptions of other embodiments.

Ordinary skilled in the field can recognize that the units and algorithm steps described in the examples combined with the disclosed embodiments can be implemented utilizing electronic hardware, or a combination of computer software and electronic hardware. Whether these functions are executed in hardware or software depends on the specific application and design constraints of the technical solution. Skilled professionals can use different methods to implement the described functions for each specific application, but such implementations should not be considered as exceeding the scope of the disclosure.

In the embodiments provided by the disclosure, it should be understood that the disclosed apparatuses/terminal devices and methods can be realized in other ways. For example, the described apparatus/terminal device embodiments are illustrative only. The division of modules or units is merely a logical functional division; in actual implementation, different partitioning methods may be used. a plurality of units or components can be combined or integrated into another system, and some features can be omitted or not executed.

The embodiments described above are intended to illustrate the technical solutions of the disclosure and are not intended to limit these solutions. Although the disclosure has been described in detail with reference to the foregoing embodiments, ordinary skilled persons in the field should understand that modifications can still be made to the technical solutions described in the foregoing embodiments, or equivalent replacements can be made to some of the technical features. The modifications or replacements do not depart from the essence of the technical solutions of the disclosed embodiments and should be included within the protection scope of the disclosure.

1-10. (canceled)

11. A method for large-scale linear circuit simulation, comprising:
constructing ordinary differential equations for a linear circuit based on a scale of the linear circuit, and converting the ordinary differential equations for the linear circuit into a large-scale sparse system of linear equations utilizing Euler iteration method;
performing column reordering on a coefficient matrix of the large-scale sparse system of linear equations to ensure all diagonal elements of the coefficient matrix are non-zero, obtaining a pre-reordered matrix;
utilizing graph partitioning algorithm to perform row-column reordering on the pre-reordered matrix to ensure the non-zero elements are distributed along a diagonal, a right border, and a lower border, obtaining a doubly bordered-block diagonal matrix;
employing a plurality of compute nodes to form distributed nodes, solving for local Schur complements of each of the distributed nodes based on data from the doubly bordered-block diagonal matrix, and summing up the local Schur complements to obtain a global Schur complement; and
solving states of each of the distributed nodes at a current time step in parallel, based on the global Schur complement and solution results from each of the distributed nodes at a previous time step; converting the solution results from all time steps of each of the distributed nodes into a simulation result for the large-scale linear circuit, based on the column reordering and the row-column reordering.

12. The method for large-scale linear circuit simulation according to claim 11, wherein the utilizing graph partitioning algorithm to perform row-column reordering on the pre-reordered matrix to ensure the non-zero elements are distributed along a diagonal, a right border, and a lower border, obtaining a doubly bordered-block diagonal matrix, comprises:
creating an original graph stack to store original graphs and a subgraph stack to store subgraphs obtained by bipartitioning, wherein the original graphs are undirected graphs corresponding to the pre-reordered matrix;
popping each of the original graphs sequentially from the original graph stack, bipartitioning the original graphs into the subgraphs to obtain bipartite subgraphs; pushing the bipartite subgraphs into the subgraph stack until the original graph stack becomes empty, swapping the original graph stack and the subgraph stack;
repeating a process of bipartitioning each of the original graphs into the subgraphs and swapping the original graph stack and the subgraph stack until number of the bipartite subgraphs in the subgraph stack or number of swaps between the original graph stack and the subgraph stack reaches a predetermined number; and
utilizing all the bipartite subgraphs to perform the row-column reordering on the pre-reordered matrix to ensure the non-zero elements are distributed along the diagonal, the right border, and the lower border, obtaining the doubly bordered-block diagonal matrix.

13. The method for large-scale linear circuit simulation according to claim 12, wherein the popping each of the original graphs sequentially from the original graph stack, bipartitioning the original graphs into the subgraphs to obtain bipartite subgraphs, comprises:
obtaining sizes of all the original graphs popped from the original graph stack; and
presetting a bipartite subgraph size threshold based on global information from all the bipartite subgraphs obtained from a previous bipartition, when the size of one original graph exceeds the preset bipartite subgraph size threshold, bipartitioning the one original graph into the subgraphs to obtain the bipartite subgraphs; otherwise, setting the one original graph as the bipartite subgraph.

14. The method for large-scale linear circuit simulation according to claim 12, wherein the utilizing all the bipartite subgraphs to perform the row-column reordering on the pre-reordered matrix, ensuring the non-zero elements are distributed along the diagonal, the right border, and the lower border, obtaining the doubly bordered-block diagonal matrix, comprises:
presetting a column reordering matrix, a doubly bordered-block diagonal reordering matrix, a row scaling matrix, and a column scaling matrix based on a dimension of the coefficient matrix;
ensuring the coefficient matrix has elements on the diagonal with an absolute value of 1, and the absolute values of off-diagonal elements do not exceed 1, based on the column reordering matrix, the row scaling matrix, and the column scaling matrix, obtaining the pre-reordered matrix; and
constructing a doubly bordered-block diagonal reordering form based on the graph partitioning algorithm, and utilizing the doubly bordered-block diagonal reordering form to perform the row-column reordering on the pre-reordered matrix, obtaining the doubly bordered-block diagonal matrix.

15. The method for large-scale linear circuit simulation according to claim 11, wherein the employing a plurality of compute nodes to form distributed nodes, solving for local Schur complements of each of the distributed nodes based on data from the doubly bordered-block diagonal matrix, and summing up the local Schur complements to obtain a global Schur complement, comprises
utilizing the plurality of compute nodes to form the distributed nodes, storing the data from the doubly bordered-block diagonal matrix on a target node, and designating the target node as a master node, designating all other nodes as slave nodes;
broadcasting data from the master node to all the slave nodes by utilizing a first message passing interface function, and solving the local Schur complements for the all distributed nodes; and
summing the local Schur complements by utilizing a second message passing interface function to obtain the global Schur complement.

16. The method for large-scale linear circuit simulation according to claim 15, wherein the broadcasting the data from the master node to all the slave nodes by utilizing a first message passing interface function, and solving the local Schur complements for the all distributed nodes, comprises:
filtering elements in the doubly bordered-block diagonal matrix corresponding to each of the distributed nodes based on the data from the master node, and constructing a block matrix by utilizing the elements corresponding to each of the distributed nodes; and
solving each of the block matrices by utilizing parallel computing method to obtain the local Schur complements for each of the distributed nodes.

17. The method for large-scale linear circuit simulation according to claim 14, wherein converting the solution results from all time steps of each of the distributed nodes into a simulation result for the large-scale linear circuit, comprises:
solving the states of each of the distributed nodes at the current time step in parallel based on the global Schur complement and the solution results from each of the distributed nodes at the previous time step;
identifying rows in the large-scale linear circuit simulation result corresponding to the solution results from all time steps of each of the distributed nodes, based on the column reordering matrix and the doubly bordered-block diagonal reordering matrix; and
scaling all elements in the rows based on the column scaling matrix to obtain the large-scale linear circuit simulation result.

18. A system for large-scale linear circuit simulation, comprising:
an initialization module, used to construct ordinary differential equations for a linear circuit based on a scale of the linear circuit, and convert the ordinary differential equations for the linear circuit into a large-scale sparse system of linear equations utilizing Euler iteration method;
a matrix pre-reordering module, used to perform column reordering on coefficient matrix of the large-scale sparse system of linear equations to ensure all diagonal elements of the coefficient matrix are non-zero, obtain a pre-reordered matrix;
a matrix reordering module, used to utilize graph partitioning algorithm to perform row-column reordering on the pre-reordered matrix to ensure the non-zero elements are distributed along a diagonal, a right border, and a lower border, obtain a doubly bordered-block diagonal matrix;
a Schur complement computation module, used to employ a plurality of compute nodes to form distributed nodes, solve for local Schur complements of each of the distributed nodes based on data from the doubly bordered-block diagonal matrix, and sum up the local Schur complements to obtain a global Schur complement; and
a circuit simulation module, used to solve states of each of the distributed nodes at a current time step in parallel, based on the global Schur complement and solution results from each of the distributed nodes at a previous time step; and convert the solution results from all time steps of each of the distributed nodes into a simulation result for the large-scale linear circuit, based on the column reordering and the row-column reordering.

19. A circuit simulator, wherein the circuit simulator comprises a simulation chip, a memory, and a large-scale linear circuit simulation program stored on the memory and executable on the simulation chip; when executed by the simulation chip, the large-scale linear circuit simulation program implements the steps of the large-scale linear circuit simulation method according to claim 11.

20. The method for large-scale linear circuit simulation according to claim 13, wherein the utilizing all the bipartite subgraphs to perform the row-column reordering on the pre-reordered matrix, ensuring the non-zero elements are distributed along the diagonal, the right border, and the lower border, obtaining the doubly bordered-block diagonal matrix, comprises:
presetting a column reordering matrix, a doubly bordered-block diagonal reordering matrix, a row scaling matrix, and a column scaling matrix based on a dimension of the coefficient matrix;
ensuring the coefficient matrix has elements on the diagonal with an absolute value of 1, and the absolute values of off-diagonal elements do not exceed 1, based on the column reordering matrix, the row scaling matrix, and the column scaling matrix, obtaining the pre-reordered matrix; and
constructing a doubly bordered-block diagonal reordering form based on the graph partitioning algorithm, and utilizing the doubly bordered-block diagonal reordering form to perform the column reordering and the row-column reordering on the pre-reordered matrix, obtaining the doubly bordered-block diagonal matrix.

21. The method for large-scale linear circuit simulation according to claim 20, wherein converting the solution results from all time steps of each of the distributed nodes into a simulation result for the large-scale linear circuit, comprises:
solving the states of each of the distributed nodes at the current time step in parallel based on the global Schur complement and the solution results from each of the distributed nodes at the previous time step;
identifying rows in the large-scale linear circuit simulation result corresponding to the solution results from all time steps of each of the distributed nodes, based on the column reordering matrix and the doubly bordered-block diagonal reordering matrix; and
scaling all elements in the rows based on the column scaling matrix to obtain the large-scale linear circuit simulation result.
